(19) United States
(12) Patent Application Publication
(10) Pub. No.: US 2025/0081982 A1
(43) Pub. Date: Mar. 13, 2025

(54) CAPSULE CONTAINING BEVERAGE POWDER, IN PARTICULAR FOR PREPARING BREWED COFFEE

(71) Applicant: SWISS COFFEE INNOVATION AG, Olten (CH)

(72) Inventor: Axel NICKEL, Hemmingen (DE)

(73) Assignee: SWISS COFFEE INNOVATION AG, Olten (CH)

(21) Appl. No.: 18/956,376

(22) Filed: Nov. 22, 2024

Related U.S. Application Data
(63) Continuation of application No. 18/173,367, filed on Feb. 23, 2023.
Application No. 18/173,367 is a continuation of application No. 15/742,438, filed on Jan. 5, 2018, now Pat. No. 12,059,008.

(30) Foreign Application Priority Data
Jul. 7, 2015 (EP) 15175704.4

(51) Int. Cl. A23F 5/38; A23F 3/32; A23G 1/40; A23G 1/46; A23G 1/56; A23P 10/30; B65D 85/804; C08B 15/10; C08B 31/00; C08B 37/00; C09D 101/02; C09D 103/04; C09D 105/00; C09D 105/04; C09D 105/08; C09D 105/12

(52) U.S. Cl. CPC A23F 5/385; A23F 3/32; A23P 10/30; B65D 85/8043; C08B 15/10; C08B 31/003; C08B 37/0039; C08B 37/0042; C08B 37/0084; C09D 101/02; C09D 103/04; C09D 105/00; C09D 105/04; C09D 105/08; C09D 105/12; A23G 1/40; A23G 1/46; A23G 1/56

(57) ABSTRACT

A capsule, especially for preparing a beverage from beverage powder, in particular of coffee from coffee powder, by introducing water into the capsule, wherein the capsule comprises a compacted pellet made of a powder containing at least one polysaccharide, wherein the compacted pellet is sheathed with at least one coating layer, wherein the at least one coating layer comprises a cross-linked polysaccharide, wherein the cross-linked polysaccharide can be obtained by cross-linking a polysaccharide with a cross-linking agent without the use of a polyol spacer.

A method for manufacturing such a capsule comprises the following steps:
i) preparing a compacted pellet from a powder containing at least one polysaccharide,
ii) bringing at least one part and preferably the entire surface of the compacted pellet used in step i) into contact with a solution of a polysaccharide in a solvent or with a dispersion of a polysaccharide in a dispersant,
iii) when appropriate, removing of the compacted pellet from the solution or dispersion of step ii),
iv) bringing the compacted pellet obtained in step ii) or iii) into contact with at least one cross-linking agent,
v) when appropriate, removing the compacted pellet from the solution of step iv) and
vi) drying of the compacted pellet obtained in step iv) or v).

This application is a continuation of U.S. application Ser. No. 18/173,367, filed Feb. 23, 2023, which is a continuation of U.S. application Ser. No. 15/742,438, filed Jan. 5, 2018, now U.S. Pat. No. 12,059,008, granted Aug. 13, 2024, which is a National Stage completion of PCT/EP2016/066197, filed Jul. 7, 2016, which claims priority from European patent application no. 15175704.4, filed Jul. 7, 2015.

### FILED OF THE INVENTION

The present invention relates to a capsule containing a beverage powder, which is particularly suitable for the preparation of a beverage, such as cocoa, tea or coffee.

### BACKGROUND OF THE INVENTION

Over the past few years, coffee capsules, besides coffee pads, have been used increasingly in the portion-wise preparation of beverages, in particular brewed coffee; the capsule walls are usually made of stainless steel, aluminium or plastic. Such capsules enable the storage of coffee powder for a fairly long period of time without loss of flavour. In addition, such capsules enable fast and user-friendly production of a portion of coffee with the desired flavour, in that a capsule containing the desired type of coffee is placed in a coffee machine adapted for this purpose, in which hot water is then pressed through the capsule, from which the desired brewed coffee is produced. However, such capsules are comparatively expensive because of the capsule material used and the production-intensive capsule construction. Furthermore, such capsules are environmentally problematic. The capsules are not recyclable, and the user usually disposes of them as residual waste. Recycling of coffee capsules therefore practically does not take place, which is particularly concerning in the case of aluminium-based coffee capsules, since the production of aluminium is very energy-intensive, resulting in such capsules having a particularly poor CO₂ balance. Another major disadvantage is that such capsules are not biodegradable and therefore cannot be disposed of biologically. Considering the fact that in Germany alone more than 2 billion coffee capsules are used annually, this is a very serious problem.

To at least partially overcome the above problems, capsules made of alternative materials have already been proposed.

For example, capsules are known from WO 2010/006979 A1 that are filled with coffee or tea in their interior and comprise a capsule wall, which in addition to the capsule contents also contains water as a structuring component. For the formation of a stable capsule wall, however, it is necessary that the capsule be cooled below the freezing point of the structuring component, because the structuring component melts when its freezing point is exceeded and moistens the capsule contents. Naturally, this restricts the use of such capsules considerably.

WO 2009/053811 A2 describes a capsule which can contain ground coffee, cappuccino powder, chocolate powder, milk powder or tea powder. The capsule consists of two half shells, which form the capsule walls. The capsule walls consist of a water-soluble material which dissolves during the brewing process. In this concept, the capsule wall material dissolves during the brewing process and thus becomes part of the prepared drink, which may undesirably affect the taste. Apart from that, the production of such capsules is complicated and expensive.

### DETAILED DESCRIPTION OF THE PREFERRED EMBODIMENTS

Taking this as the point of departure, the present invention is based on the objective of providing a capsule for the portion-by-portion preparation of beverages from beverage powder, such as cocoa, tea and coffee, which can not only be produced in a simple and cost-effective manner, but which, in particular, is also biodegradable and can therefore be disposed of in an environmentally friendly manner; the capsule can also be stored over a long period of time without any appreciable loss of flavour and can be used in correspondingly designed beverage vending machines.

According to the invention, this objective is achieved by a capsule, wherein the capsule comprises a compacted pellet of a powder containing at least one polysaccharide, such as in particular coffee powder, wherein the compacted pellet is sheathed with at least one coating layer, with the at least one coating layer comprising a cross-linked polysaccharide, wherein the cross-linked polysaccharide has been or can be obtained by the cross-linking of a polysaccharide with a cross-linking agent without the use of a polyol separator or polyol spacer.

This solution is based on the recognition that such a capsule consisting of a compacted pellet composed of a powder containing at least one polysaccharide, such as coffee powder, wherein the compacted pellet is sheathed by at least one coating layer composed of a cross-linked polysaccharide, not only exhibits all the necessary properties which are required for the use thereof in the portion-by-portion preparation of beverages, such as coffee, but in particular can also be disposed of in an environmentally friendly manner. In particular, the at least one coating layer composed of a cross-linked polysaccharide is stable enough to provide the capsule with sufficiently high transport protection, as well as handling protection. Apart from that, according to the invention, the capsule also protects the capsule content over a prolonged period of time without a noticeable loss of flavour. This is based on a synergistic cooperation of the at least one coating layer composed of cross-linked polysaccharide and the compacted pellet. The pressing of the coffee powder into a compacted pellet means that the surface area of the coffee powder which is accessible to oxygen is significantly reduced compared to powder in a not compacted form. In addition, the sheathing composed of a cross-linked polysaccharide functions as a further oxygen barrier. The combination of the reduced surface area and the sheathing thus results in preservation of the flavour of the capsule content. A further advantage of the capsule according to the invention consists in the fact that the at least one coating layer does not dissolve during the preparation of the beverage and consequently does not cause any adulteration of the taste of the prepared beverage. Aside from this, the capsule according to the invention can be produced in a simple and cost-effective manner. In addition, the capsule according to the invention can easily be produced in a spherical form and is thus excellently suited for use in a correspondingly adapted automatic beverage vending machine, because it can roll. Moreover, of particular importance is that the at least one cross-linked polysaccharide coating is completely biodegradable and can therefore be disposed of in an environmentally friendly manner. Because polysaccharides are not of fossil origin and their production is comparatively less energy intensive, the capsule according to the invention exhibits an advantageous CO₂ balance.

In principle, the present invention is not limited with regard to the chemical nature of the polysaccharide of the at least one coating layer. Good results are obtained when the polysaccharide of the at least one coating layer is selected from the group consisting of starch, cellulose, chitin, carrageenan, agar and alginates. Particularly preferred would be for the polysaccharide of the at least one coating layer to comprise a carrageenan or an alginate, whereby it is more particularly preferred that the polysaccharide of the at least one coating layer is an alginate. In the context of the present invention, it has been found that these polysaccharides do not cause any adulteration of the taste during the preparation of the beverage. In the context of the present invention, it has also been found that compacted pellets, in particular those composed of coffee powders, can easily be sheathed with alginate in a cost-effective manner. Alginates are biodegradable and provide a sufficiently stable sheathing and protection for the contents of the capsule without a significant loss of flavour. In the context of the present invention, it has also been found that alginates are able to reduce water hardness. An unpleasant acid taste is thereby lessened.

It is essential to the invention that the polysaccharide of the at least one coating layer is cross-linked. According to one embodiment of the present invention, the polysaccharide can be cross-linked via covalent bonds. Cross-linking via covalent bonds enables very durable sheathings. At the same time, cross-linking via covalent bonds usually takes place through the reaction of the polysaccharide with a suitable cross-linking agent. Particularly suitable cross-linking agents are difunctional organic compounds, wherein the functional groups are selected, for example, from the group that consists of carboxylic acids, salts of carboxylic acids, activated carboxylic acids, amines, alcohols, aldehydes and ketones. In this context, activated carboxylic acids are carboxylic acid halides, active esters of carboxylic acids, anhydrides of carboxylic acids or other reactive derivatives of carboxylic acids. Preferably, the cross-linking is carried out without the use of a spacer and, particularly, without a polyol spacer.

According to an alternative and particularly preferred embodiment of the present invention, the polysaccharide of the at least one coating layer is cross-linked via ionic and/or coordinative bonds. Such polysaccharides cross-linked via ionic and/or coordinative bonds can be produced in a particularly easy manner and do not impair the biodegradability of the polysaccharide used. The ionic and/or coordinative cross-linking can be achieved, for example, by means of polysaccharides which have anionic groups such as carboxylate groups or sulfonate groups. By introducing divalent or higher-valent cations, in particular alkaline earth metal ions, ionic or coordinative cross-linking of the anionic groups of the polysaccharide then takes place in order to form a stable sheathing layer.

In this context, a coordinative bond denotes an interaction between an electron pair donor and an electron pair acceptor, for example, such as can take place between free electron pairs of oxygen atoms in hydroxyl groups and cations.

More particularly preferred, in the case of the cross-linked polysaccharide, would be an alkaline earth metal alginate, and maximally preferred would be a calcium alginate. In this case, the calcium ions are the cross-linkers because they enter into coordinative or ionic bonds with groups of the alginate. In the context of the present invention, it has surprisingly been found that a sheathing comprising calcium alginate provides a water-insoluble layer which does not impair the taste of the beverage produced from the capsule and provides sufficient stability of the capsule in order to ensure protection during transport and handling without the capsule contents suffering a significant loss of flavour. Moreover, calcium alginate is excellently biodegradable. A further advantage is that calcium alginate is an approved food additive with the E-number E405 and is therefore harmless to health. It is additionally preferred in this embodiment that the content of the capsule, that is to say the compacted pellet composed of polysaccharide, is at least substantially free of alkaline earth metal ions and in particular calcium ions, by which is meant that the compacted pellet, except for the polysaccharide of which the compacted pellet is made and which might contain natural alkaline earth metal ions and in particular calcium ions, shall contain no further alkaline earth metal ions and in particular no calcium ions. It is particularly preferred that the compact pellet contained in the capsule or at least 80% of the internal volume of the compacted pellet should have an alkaline earth metal ion concentration and in particular a calcium ion concentration of less than 1 mol/l; less than 0.1 mol/l is preferred; even more preferred is less than 0.001 mol/l and particularly preferred is less than 0.001 mol/l; more particularly preferred would be less than 0.0001 mol/l and maximally preferred would be less than 0.00001 mol/1. “80% of the internal volume of the compacted pellet” is understood to mean the volume which is obtained when a spherical surface is spanned from the longest section leading radially from the centre point to the outer surface of the compacted pellet around the point lying at 80% starting from the centre point to the outer surface point. Contamination of the compacted pellet with alkaline earth metal ions and in particular calcium ions can be prevented in that the alkaline earth metal ions and in particular calcium alginate coating are produced in that the compacted pellet is first contacted with the alkali metal alginate solution and only thereafter, during the formation of the calcium alginate coating, with a liquid containing alkaline earth metal ions and especially calcium ions, and is not first contacted with a fluid containing an earth metal alginate and particularly calcium ions before an alkali metal alginate solution is added.

In principle, the capsule according to the invention can comprise only a coating layer of cross-linked polysaccharide. In order to increase the stability of the capsule and thus the transport safety and the handling protection, it is proposed in a further development of the inventive concept that the capsule according to the invention should comprise two or more coating layers. Preferably, the compacted pellet of the capsule is to be sheathed with 2 to 100 coating layers; particularly preferred would be 2 to 20 and more particularly preferred would be 2 to 10 and maximally preferred would be 2 to 5 coating layers. The sheathing of the compacted pellet of the capsule with two or more coating layers also increases the effect of the coating as an oxygen barrier as well as the resulting provision of effective aroma protection to a particularly high degree.

It has been found that the first coating layer penetrates as a gel into the still rough surface of the compacted pellet and leads to a smoother surface. This means a further surface area reduction, which enhances the flavour density further. An even smoother surface is then achieved with further coating layers, and this also exhibits the necessary stability, so that even harder shocks can be absorbed without a damaging effect.

According to a further, particularly preferred embodiment of the present invention, the coating of the capsule consists of 2 to 100 calcium alginate coating layers; preferred would be 2 to 20, particularly preferred would be 2 to 10 and highly preferred would be 2 to 5 layers with which the compacted pellet is to be sheathed.

The individual coating layers feature, depending on the viscosity of the sodium alginate and the procedure followed, thickness ranging between 50 and 600 μm. Particularly preferred would be layer thicknesses of up to 100 to 300 μm for the first coating layer, since they exhibit the optimum compromise between stability and drying speed. Subsequent coating layers are preferably thinner and are preferably between 50 and 200 microns thick to enable rapid drying.

A thin coating layer is preferred in order to remove the water contained in the gel more easily, and to facilitate the fastest possible diffusion of the cross-linking agent, that is the calcium ions, into the sodium alginate. In principle, the rate of diffusion of the calcium ions into the sodium alginate can also be increased with a higher concentration of the cross-linking agent; however, in the practical implementation of this variant, thin coating thicknesses have proven to be advantageous for the speed of the diffusion and handling.

The present invention is not particularly limited with regard to the material from which the compacted pellet of the capsule according to the invention is made. Good results are obtained when the compacted pellet contains or preferably is composed of or consists of a material which is selected from the group consisting of coffee, tea, drinking chocolate, cocoa and milk powder. Good results are obtained in particular when the compacted pellet consists of ground coffee powder.

In the context of the present invention, a compacted pellet is understood to mean compressed powder. Good results are obtained, in particular, if the compacted pellet of the capsule according to the invention is made by pressing powder, in particular coffee powder, with a pressure of 0.01 to 1000 MPa, preferably 0.05 to 500 MPa, particularly preferably 0.1 to 100 MPa, even more preferably 0.5 to 100 MPa, still more preferably 1 to 100 MPa, more particularly preferably 5 to 50 MPa, and most preferably 15 to 30 MPa. In this manner, sufficient compression can be provided for secure sheathing of the compacted pellet, and a good oxygen barrier can be achieved. At lower pressures, there is no sufficient cohesion and at higher pressures too strong cohesion occurs, which under some circumstances becomes relaxed after removal from the press, possibly leading to the destruction of the capsules.

The present invention further relates to a capsule which comprises a compacted pellet made from a powder of a substance selected from the group consisting of coffee, tea, drinking chocolate, cocoa and milk powder, wherein the compacted pellet is obtained by pressing the powder at a pressure of 0.01 to 1.000 MPa, preferably 0.05 to 500 MPa, particularly preferably 0.1 to 100 MPa, further preferably 0.5 to 100 MPa, still more preferably 1 to 100 MPa, more particularly preferably 5 to 50 MPa and most preferably 15 to 30 MPa, and wherein the compacted pellet is sheathed with 1 to 100, preferably with 2 to 20, particularly preferably with 2 to 10 and maximally preferably with 2 to 5 coating layers of calcium alginate. Maximally preferred is when the capsule, according to the invention, consists of a compacted pellet obtained from a powder of a substance selected from the group consisting of coffee, tea, drinking chocolate, cocoa and milk powder with a pressure of 15 to 30 MPa, and wherein the compacted pellet is sheathed with 2 to 20 coating layers of calcium alginate.

In principle, the compacted pellet can have any shape, for example, the shape of a truncated cone, cone, ellipsoid, cylinder, cuboid, a coffee bean or a sphere. The capsule according to the invention, particularly preferably has the shape of a sphere, since the ratio of surface to volume is lowest in this case, as a result of which the aroma is particularly well preserved. In addition, the spherical shape allows the capsule to roll and therefore to be used particularly well in a beverage vending machine.

The present invention further relates to a method for producing a capsule which comprises the following steps:
i) preparing a compacted pellet from a powder containing at least one polysaccharide,
ii) bringing at least part of the surface and preferably the entire surface of the compacted pellet used in step i) into contact with a solution of a polysaccharide in a solvent or with a dispersion of a polysaccharide in a dispersant,
iii) when appropriate, removing of the compacted pellet from the solution or dispersion of step ii),
iv) bringing the compacted pellet obtained in step ii) or iii) into contact with at least one cross-linking agent,
v) when appropriate, removing the compacted pellet from the solution of step iv) and
vi) drying of the compacted pellet obtained in step iv) or v).

The bringing into contact of the compacted pellet in step ii) is preferably carried out in such a way that at least a part of the surface and preferably the entire surface of the compacted pellet is wetted with the solution or dispersion of the polysaccharide. For example, the contacting of the compacted pellet in steps ii) and iv) is carried out independently of one another by immersion, spraying or coating of the compacted pellet with the solution or dispersion of the polysaccharide or with the cross-linking agents.

The method according to the invention makes it possible to sheath the compacted pellet evenly. Particularly even when the compacted pellet is spherical, without creating an edge or a seam.

The solvent or dispersant is preferably a water-based solvent or dispersant. Water is particularly preferred as the solvent or dispersant.

The compacted pellet in step ii) is preferably immersed in or sprayed with an aqueous 0.5 to 5 wt % alkali metal alginate solution. Particularly preferred is to immerse or spray the compacted pellet in step ii) with an aqueous 1 to 2 wt % alkali metal alginate solution. At a concentration of less than 0.5 wt %, the alkali metal alginate solution is not concentrated enough and is too low in viscosity to apply a sufficient amount of alkali metal alginate to the compacted pellet by simple dipping or spraying in order to produce a sufficiently stable sheathing in the following steps. If the concentration of the alkali metal alginate exceeds 5 wt %, the viscosity of the alkali metal alginate solution is so high that the formation of a full sheathing is impeded. In addition, the coating thicknesses increase at a concentration of the alkali metal alginate of over 5 wt %. so that drying becomes more difficult.

The alkali metal alginate solution is preferably a solution of a salt, which consists of alginate and a cation of an alkali metal or a related cation such as, for example, an ammonium ion. Particularly preferably, the alkali metal alginate solution is an aqueous solution of sodium alginate, potassium alginate or ammonium alginate. Sodium alginate, potassium alginate and ammonium alginate are approved food additives with E-numbers E401, E402 or E403. Such sheathings can be used without hesitation in the food industry. More particularly preferred is an aqueous solution of sodium alginate.

In the method of the present invention, it is preferred to immerse or to spray the compacted pellet in step iv) in/with an aqueous 1 to 15 wt %, preferably 1 to 7 wt %, alkaline earth metal salt solution. In the case of an alkaline earth metal salt concentration between 1 and 15 wt %, preferably between 1 and 7 wt %, rapid ionic cross-linking of the polysaccharide can be achieved. The alkaline earth metal salt is preferably a calcium salt, such as calcium chloride in particular.

Because the compacted pellet is first contacted with an alkali metal alginate solution and is only thereafter contacted with a liquid containing alkaline earth metal ions and, in particular, calcium ions, under formation of the coating containing alkaline earth metal ions and, in particular, a calcium alginate, it is achieved that the compacted pellet composed of polysaccharide in the capsule is at least substantially free of alkaline earth metal ions and in particular calcium ions. This is understood to mean that the compacted pellet contained in the capsule contains no further alkaline earth metal ions and in particular calcium ions apart from the naturally contained alkaline earth metal ions and in particular calcium ions possibly present in the polysaccharide from which the compacted pellet was made. It is particularly preferred that the compact pellet contained in the capsule or at least 80% of the internal volume of the compacted pellet should have an alkaline earth metal ion concentration and in particular a calcium ion concentration of less than 1 mol/l; less than 0.1 mol/l is preferred; even more preferred is less than 0.001 mol/l and particularly preferred is less than 0.001 mol/l; more particularly preferred would be less than 0.0001 mol/l and maximally preferred would be less than 0.00001 mol/1. “80% of the internal volume of the compacted pellet” is understood to mean the volume which is obtained when a spherical surface is spanned from the longest section leading radially from the centre point to the outer surface of the compacted pellet around the point lying at 80% starting from the centre point to the outer surface point.

In order to encapsulate a compacted pellet with several layers, steps ii) to v) or steps ii) to vi) can be repeated several times, namely preferably 2 to 20 times and particularly preferably 2 to 10 times and maximally preferably 2 to 5 times.

Drying in step vi) can be carried out in different ways, whereby various drying methods have proved to be successful. A very even drying can be achieved, although not exclusively, through drying in a stream of air in suitable channels, wherein the compacted pellet floats freely and dries evenly by its own rotation. To better absorb the water that diffuses out through the coating layer during its formation, contact drying on absorbent or warm surfaces has also proven to be useful. Both principles can be combined in a type of fluidized bed channel. Infrared dryers and microwave dryers can also be used as other very efficient drying principles.

The present invention further relates to the use of the capsule according to the invention for producing a beverage by bringing the capsule according to the invention into contact with water. Preferably, the capsule contains a material which is selected from the group consisting of coffee, tea, drinking chocolate, cocoa and milk powder.

The use of the capsule according to the invention for the preparation of a coffee beverage allows the portion-by-portion preparation of the beverage depending on the needs as required. A particular advantage of the application according to the invention is that only biodegradable waste is produced.

When using the capsule according to the invention for preparing a beverage, in particular a coffee beverage, the coffee capsules are preferably crushed or perforated before the extraction of the crushed or perforated coffee capsule with water takes place.

Hereinafter, the present invention will be explained on the basis of two examples which are meant to illustrate but are non-limiting.

### Example 1

8 g of ground roasted coffee were pressed into a spherical compacted pellet with a press at a pressure of 20 MPa. The resulting spherical compacted pellet was then immersed in a 1 wt % aqueous sodium alginate solution and after 1 to 2 seconds, removed from the sodium alginate solution. After removal of the compacted pellet from the sodium alginate solution, it was sprayed with a 5 wt % CaCl₂ solution. Then, the compacted pellet was dried for 10 minutes at room temperature in a stream of air.

A capsule consisting of a compacted pellet with an encapsulated layer of calcium alginate was obtained.

### Example 2

A coffee capsule was prepared as in Example 1, except that the steps of immersing the compacted pellet in the sodium alginate solution, removing from the sodium alginate solution, spraying with the calcium chloride solution and drying are to be repeated successively for a total of 5 times each.

A capsule consisting of a compacted pellet with five encapsulated layers of calcium alginate was obtained.

1. A capsule, in particular for preparing a beverage from beverage powder, in particular from coffee powder, by introducing water into the capsule, wherein the capsule comprises a compacted pellet made of a powder containing at least one polysaccharide, wherein the compacted pellet is sheathed with at least one coating layer, wherein the at least one coating layer comprises a cross-linked polysaccharide, wherein the cross-linked polysaccharide can be obtained by the cross-linking of a polysaccharide with a cross-linking agent without the use of a polyol spacer.

2. The capsule according to claim 1, characterised in that the polysaccharide of the at least one coating layer is selected from the group consisting of starch, cellulose, chitin, carrageenan, agar and alginates.

3. The capsule according to claim 2, characterised in that the polysaccharide of the at least one coating layer is an alginate.

4. The capsule according to one of the preceding claims, characterised in that the polysaccharide of the at least one coating layer is cross-linked via covalent bonds.

5. The capsule according to one of claims 1 to 3, characterised in that the polysaccharide of the at least one coating layer is cross-linked via ionic and/or coordinative bonds.

6. The capsule according to claim 5, characterised in that the cross-linked polysaccharide of the at least one coating layer is an alkaline earth metal alginate, preferably a calcium alginate.

7. The capsule according to one of the preceding claims, characterised in that the compacted pellet is sheathed with 1 to 100 coating layers; preferred would be 2 to 20, particularly preferred would be 2 to 10 and maximally preferred would be 2 to 5 coating layers.

8. The capsule according to any one of claim 3, 6 or 7, characterised in that the compacted pellet is sheathed with 2 to 100, preferably with 2 to 20, particularly preferably with 2 to 10 and maximally preferably with 2 to 5 coating layers of calcium alginate.

9. The capsule according to one of the preceding claims, characterised in that the compacted pellet contains or is preferably composed of a material selected from the group consisting of coffee, tea, drinking chocolate, cocoa and milk powder.

10. The capsule according to one of the preceding claims, characterised in that the compacted pellet can be obtained by pressing the powder with a pressure of 0.01 to 1000 MPa, preferably 0.05 to 500 MPa, particularly preferably 0.1 to 100 MPa, even more preferably 0.5 to 100 MPa, still more preferably 1 to 100 MPa, more particularly preferably 5 to 50 MPa, and maximally preferably 15 to 30 MPa.

11. The capsule according to claim 1, characterised in that the capsule comprises a compacted pellet made from a powder of a substance selected from the group consisting of coffee, tea, drinking chocolate, cocoa and milk powder, wherein the compacted pellet is obtained by pressing the powder at a pressure of 0.01 to 1.000 MPa, preferably 0.05 to 500 MPa, particularly preferably 0.1 to 100 MPa, further preferably 0.5 to 100 MPa, still more preferably 1 to 100 MPa, more particularly preferably 5 to 50 MPa and maximally preferably 15 to 30 MPa, and wherein the compacted pellet is encapsulated with 1 to 100, preferably with 2 bis 20, particularly preferably with 2 to 10 and maximally preferably with 2 to 5 coating layers of calcium alginate.

12. A method for manufacturing a capsule according to any one of the preceding claims, comprising the following steps:
i) preparing a compacted pellet from a powder containing at least one polysaccharide,
ii) bringing at least one part and preferably the entire surface of the compacted pellet used in step i) into contact with a solution of a polysaccharide in a solvent or with a dispersion of a polysaccharide in a dispersant,
iii) when appropriate, removing of the compacted pellet from the solution or dispersion of step ii),
iv) bringing the compacted pellet obtained in step ii) or iii) into contact with at least one cross-linking agent,
v) when appropriate, removing the compacted pellet from the solution of step iv) and
vi) drying of the compacted pellet obtained in step iv) or v).

13. The method according to claim 12, in which the compacted pellet in step ii) is dipped in or sprayed with an alkali metal alginate solution and preferably an aqueous 0.5 to 5 wt % alkali metal alginate solution and particularly preferably an aqueous 0.5 to 5 wt % sodium alginate solution.

14. The method according to claim 12 or 13, in which the compacted pellet in step iv) is dipped in or sprayed with an alkaline earth metal salt solution, preferably an aqueous 1 to 7 wt % alkaline earth metal salt solution and particularly preferably an aqueous 1 to 7 wt % calcium chloride solution.

15. Use of a capsule according to one of the claims 1 to 11 for preparing a coffee beverage.
